(19) United States
(12) Patent Application Publication
(10) Pub. No.: US 2005/0008122 A1
(43) Pub. Date: Jan. 13, 2005

(54) Method and device for the recording of objects

(76) Inventors: Albert Geisser, Luzern (CH); Bruno Rudolf, Kezmann (CH)

Correspondence Address: George W Rauchfuss Jr;Ohlandt Greeley Ruggiero & Perle, Tenth Floor, One Landmark Square, Stamford, CT, 06901-2682, US

(21) Appl. No.: 10/496,038

(22) PCT Filed: Nov. 15, 2002
(86) PCT No.: PCT/IB02/04765

(30) Foreign Application Priority Data
Nov. 22, 2001 (EP) 01127371.1

(51) Int. Cl. G21K 5/10

(52) U.S. Cl. 378/146

(57) ABSTRACT

The invention relates to the recording of an object (4) by imaging with a radiation source (2) on a recording medium (3) using aperture (6), the size of which may be adjusted using adjusting means (7), depending on the size of said object. Sensors (8) are provided for determination of object size. The quality of the images, which are in particular X-ray images, can thus be improved.

### CROSS REFERENCES TO RELATED APPLICATIONS

This application claims the priority of the European patent application No. 01 127 371.1 of 22 Nov. 2001, the disclosure of which is incorporated herein by reference in its entirety.

### TECHNICAL FIELD

The invention relates to a method according to the preamble of claim 1 as well as a device according to the preamble of claim 12. Furthermore, the invention relates to a method or a device, respectively, according to the preamble of claims 18 or 24, respectively.

### BACKGROUND ART

In photo technique moving apertures (shutter, shutter apertures) for the dosage of the amount of light are known, whereby e.g. the breadth of the aperture for the variation of the amount of light can be differently adjusted.

In radiology, apertures are known as collimators which serve with constant dimensions for the reduction of the produced radiation dosage, but which, according to U.S. Pat. No. 4,773,087, also are used for the reduction of scattered radiation. Furthermore, collimators can be adjustable in order to, adjusted to the object to be recorded, limit the radiated area. In this way, it is shown in U.S. Pat. No. 4,122,350 a size-adjustable collimator for the limitation of the area impinged by rays in mammography, whereby no relative movement between the object and radiation source occurs. From U.S. Pat. No. 4,603,427, an adjustable collimator is known by means of which the height of the irradiated area can be limited in connection with cephalometric panorama photos. The breadth of the section of the ray beam and the slewing plane is determined by a non-adjustable slit at the exit of the radiation source. Perpendicular to the slewing plane, the ray beam is limited by the height-adjustable collimator, whereby signaling rods show the limitation of the height. From U.S. Pat. No. 3,518,435, an adjustable collimator is known, which limits the irradiated area depending on the film cassette size used. In connection with the type of recording shown, no relative movement between the object and the radiation source occurs. In general, it is known in radiology to use collimators for the limitation of the irradiated area and, prior to the real recording, to display the limited area for the control thereof on the object (patient) by means of visible light. Furthermore, collimators for the limitation of the X-rays are used when using line detectors such that the radiosensitive line detector is exclusively irradiated. In classic photographic radiology, radiation grids are also used for the reduction of the scattered radiation. However, this method for the reduction of scattered radiation also weakens simultaneously the wanted radiation so that, for the production of a high-contrast image, high dosages of X-rays have to applied. These radiation grids, which are between the object and the image, are constant in their dimensions. The absorption of undesired scattered radiation by the recording means during the image recording generally leads to a declined wanted signal/unwanted signal ratio and thus not to an optimal image quality.

### DESCRIPTION OF THE INVENTION

It is the object of the present invention to improve the image quality.

In connection with a method of the type mentioned above, this is achieved by means of the characterizing features of claim 1. In connection with a device mentioned above, this is achieved by means of the characterizing features of claim 12.

Since an aperture with a focal aperture, which is dependent on the object size, is used, the scattered radiation can be especially well reduced what increases the image quality. It has appeared that, in particular in connection with X-ray photography, that the aperture, which is dependent on the object size, leads to more sharply-defined images which allow a better interpretation of the image of the object.

Preferably, the method is used for the recording of radiographs. Preferably, it is also provided a device for the determination of the object size which controls the adjustment of the aperture opening.

A further object of the invention is also to improve recordings by means of sound waves. In connection with a method or a device, respectively, of the type mentioned above, this is achieved by means of the characterizing portion of claim 18 or 24, respectively.

Also in connection with recordings by means of sound waves, an improvement of the record quality can be achieved by means of the aperture size which is adjusted depending on the object.

### BRIEF DESCRIPTION OF THE DRAWINGS

In the following, embodiments of the invention are explained by means of the description and the drawings. Thereby, it is shown by

FIG. 1 a schematic view of the inventive procedure or a device, respectively, in order to x-ray an object;

FIG. 2 a schematic top view onto the aperture of FIG. 1;

FIG. 3 a cross sectional view along the line A-A of FIG. 2 as well as a variant of the aperture;

FIG. 4 a schematic view of a modification of the procedure or the device, respectively, of FIG. 1;

FIG. 5 a further embodiment;

FIG. 6 a further embodiment of the aperture;

FIG. 7 an embodiment with two apertures; and

FIG. 8 a schematic embodiment in connection with which sound waves are emitted and received.

### BEST MODE FOR CARRYING OUT THE INVENTION

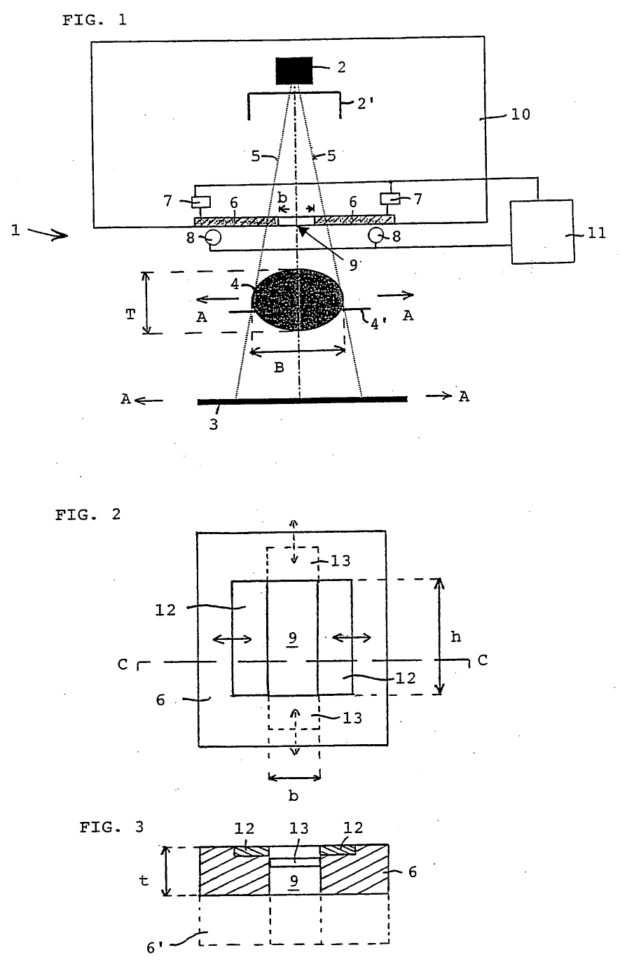

Scattered radiation, which e.g. always arises in connection with the imaging of objects by means of light waves or X-rays, is contrast decreasing regarding the image since it reduces the desired optimal contour sharpness of the object. Scattered light is produced in connection with imaging of objects by means of object-related reflections or by means of ionizing radiation which penetrates the object. Diffuse contours, which are produced accordingly, are the reasons for the worse contrast of the imaging of the object and can lead to undetermined conclusions when analyzing the imaging since, because of lack of significance of the imaging, a reliable statement about the object is made impossible. FIG. 1 shows now a first embodiment in ground view having an aperture, which is adjusted depending on the object, by means of which the scattered light is reduced. Adjusted depending on the object means thereby that the object size, actually the volume of the object, but in a simplified manner also only the area of the object which is turned towards the radiation, or even only one dimension of this area, is taken into account in order to proportionally adjust the aperture to this object size, which aperture only let pass a part of the radiation which is emitted by the radiation source in direction to the object (with or without the collimator). Thereby, FIG. 1 shows schematically a device 1 by means of which an object 4 is x-rayed in order to produce an imaging of the object 4 onto a recording means 3. Thereby, the device 1 is e.g. an industrial or medical X-ray equipment which x-rays a technical object 4 or a patient and produces the image onto an X-ray film or an X-ray plate. Accordingly, the radiation source 2 is an X-ray tube. For the object, it is provided a known object carrier 4′ which is only suggested by means of two lines laterally to the object. However, if the object 4 is transparent, the radiation source 2 could also be a light source, which produces an image onto a photographic film 3. The radiation source 2, which is arranged in a schematically illustrated container, produces X-rays which cone or, if need be, differently shaped contour is suggested in the Figure by means of boundary lines 5. Thereby, the radiation source 2 is e.g. in a container 10, which is closed vis-à-vis the object 4 by means of the aperture 6. The aperture can also be arranged separately, independent of the container. The aperture 6 comprises an opening 9 through which accordingly a part of the x-rays can exit the container 10 through the focal aperture, while the rest of the X-rays is barred from the exit of the container by means of the aperture 6. In the illustrated example, the object is arranged such that it can be met from the entire X-ray cone as it exits the source 2 and is suggested by means of the lines 5. The radiation which exits the source 2 can be limited in a known manner by means of a collimator 2′ which is only suggested; in this case, the lines 5 represent the radiation which is already limited, which also can only extend along a part of the object 4 if only this part should be imaged or only this part is moved relative to the ray, respectively. In connection with the arrangement of FIG. 1 it is assumed that the container 10 with the source 2 and the aperture 6 is stationary whereas the object 4 as well as the recording means 3 pass by between the aperture 6 and the recording means 3 in direction of the arrow A. The opening 9 of the aperture 6, which is illustrated in cross-section, is thereby adjusted depending on the size of the object 4, in any case, on the aperture dimension which corresponds to the movement direction. In the present case, the breadth b of the focal opening 9 which is in direction of the movement (arrow A) is adjusted. This is schematically illustrated in FIG. 1 by means of two sensors 8, which measure the object 4, e.g. contact-free by means of an ultrasonic measuring or an optic measuring. Sensors can also be provided which contact the object in order to record its dimension for the aperture adjustment. This measuring preferably occurs prior to the image record in a separate step. According to the measuring data, the size of the focal aperture 9 is determined by a control equipment 11 and adjusted by e.g. a servo motor 7 which is operated by a control equipment 11. An interesting dimension in connection with the recording situation of FIG. 1 is the breadth B of the object which is traversed by means of the relative movement in direction of the arrow A. According to this breadth B, the breadth b of the slit-shaped focal aperture of the aperture 6 is adjusted which is slit-shaped in the present example. Thereby, the breadth b of the focal aperture is selected x-times smaller than the breadth B of the object, whereby x is in the range of 10 to 100'000, so that the slit breadth is 10 times to 100'000 times smaller than the breadth B of the object. In case of a ray which is already limited by means of collimation or a differently arranged object of which only a part is imaged, the focal aperture can also be selected as proportional to the breadth B of the part of the object. Furthermore, the height of the slit opening of the aperture 6 is preferably also adjusted according to the height of the object 4, i.e. the extension perpendicular to the drawing plane of the object 4. For this, e.g. the same divider can be used as in case of the adjustment of the breadth so that the height of the slit is also 10 times smaller to 100'000 times smaller than the height of the object 4. Then, the object 4 is imaged accordingly by means of an X-ray which is limited by the aperture which is adjusted according to the object size, whereby for this, the object and the imaging means or the X-ray plate 3, respectively, are passed by together several times along the resting and screened off radiation source 2, each time correspondingly shifted in height so that the imaging is produced stripe by stripe. As mentioned, it has appeared that, by means of a corresponding adjustment of the aperture 6 according to the proportion of the object size, an especially good reduction of the scattered light and thus an increase of the imaging quality is achievable.

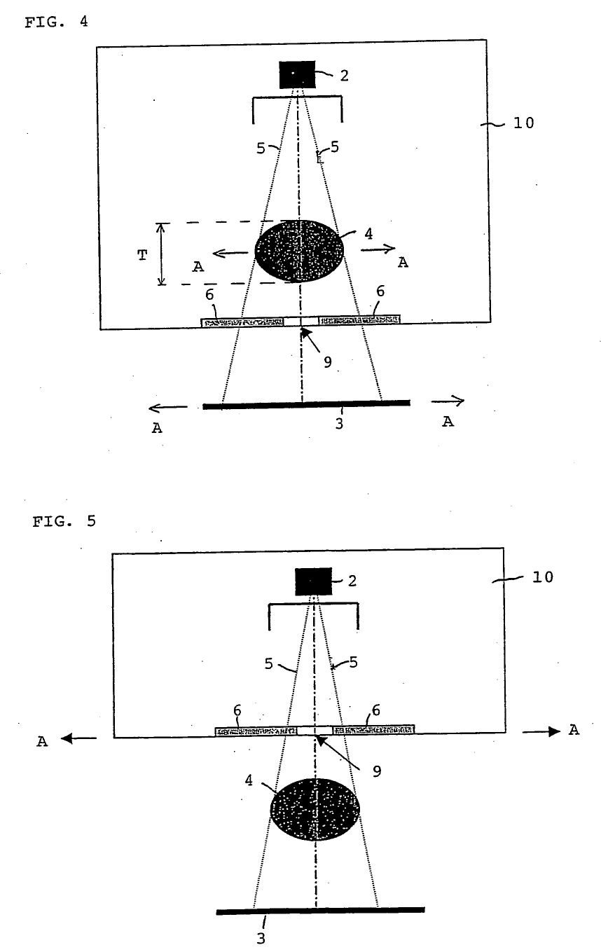

FIG. 2 shows a schematic a view of the aperture 6, whereby, according to FIG. 1, it is a slit aperture with a slit 9. This slit 9 can be adjusted in its height h and its breadth b by means of movable aperture elements 12 and 13, which are movable relating to each other. This occurs by means of the operation means suggested in FIG. 1 which can be motor, pneumatic or hydraulic operation means. Accordingly, FIG. 3 shows a sectional view through the aperture 6 of FIG. 2, whereby equal elements are designated by equal reference numbers. The aperture can also be differently adjustable in its depth t, wherefore for this reason, the depth T of the object preferably is also measured. Thereby, an adjustment of the depth can be achieved such that several of the apertures are arranged in series as this is shown in FIG. 3 with a further aperture 6′ which is only suggested.

The inventive application of the aperture for the reduction of the scattered radiation is possible for the entire spectrum of the electromagnetic radiation. The smaller the object to be imaged, the smaller should be the aperture, whereby the ratio of the proportions (aperture to object) can be as mentioned from 1:10 to 1:100'000. In order to achieve a scattered radiation reduction which is as good as possible, it is preferred a proportionality which is as high as possible, e.g. between 1:10'000 to 1:100'000. For this, e.g. the breadth of the opening of the aperture in the micrometer range is desirable. In particular in connection with very small objects, e.g. smaller than 1 mm, the optimal ratio aperture:object can only be achieved with a technical complex solution, e.g. focal aperture in the range of e.g. 10 to 100 micrometers. In this case it shifted again to a lower proportionality, e.g. 1:10 or 1:50.

FIG. 4 shows a further embodiment of the invention, whereby the same reference numbers as used in the previous Figures designate the same elements. In connection with this embodiment, the aperture, which is also shown in cross-section, is arranged between the object 4 and the recording means 3. Thereby, the object 4 and the recording means 3 are again passed by the stationary aperture 6 and the stationary radiation source according to the arrow A. According to the height h of the slit and the severalfold bigger height of the object 4, the passing-by-movement happens several times with shifted height positions of the aperture and the object. For the simplification of the Figure, means 7, 8 and 11 are not shown, but are also present in connection with the device. According to the invention, anyway, the dimension of the aperture is also adjusted in this case, which corresponds to the relative movement, whereby in the present case, the breadth b is again proportional to the breadth of the object 4. The ray exits the source 2, if need be, through a collimator.

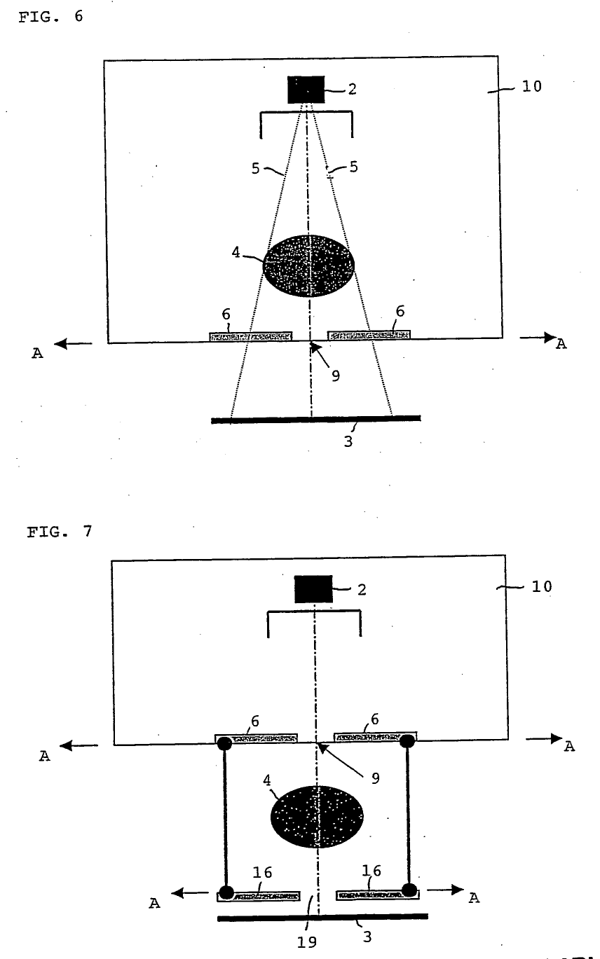

FIG. 5 shows a further embodiment in connection with which the same elements are designated again with the same reference numbers and means 7, 8 and 11 are not shown, whereby the radiation source 2 and the aperture 6 are passed by the resting object and the resting imaging means 3 according to the arrow A. Also in this case, the image can be produced line by line onto the recording means 3 according to the height of the slit of the aperture 6. FIG. 6 shows a corresponding embodiment, whereby the aperture is arranged between the object 4 and the recording means 3. Also the apertures of FIGS. 5 and 6 are each adjusted in their slit breadth b according to the direction of the pass by of the aperture.

FIG. 7 shows a further embodiment, whereby two apertures 6 and 16 with the openings 9 and 19 are provided, whereby one aperture is provided between the radiation source and the object and the other aperture between the object and the imaging means 3. Thereby, the apertures are moved synchronously with the radiation source 2 in order to scan the object line by line. Thereby, the focal opening 9 is adjusted again in its breadth b depending on the object, preferably, this also occurs in connection with the focal aperture 19.

A preferred application of the invention lies in the medical X-ray technique and in the industrial X-ray technique for the checking of the materials.

Another embodiment which is not shown in the Figures is that the object is illuminated by means of visible light and a record of this object is produced onto a recording means, e.g. a photographic film. Also in this case, the image quality can be improved by means of the provision of an object-related size-adjusted aperture. The aperture, which is adjusted in its size depending on the object, can thereby undertake at the same time the function of a shutter, whereby the shutter speed is determined e.g. by means of the movement speed of the aperture.

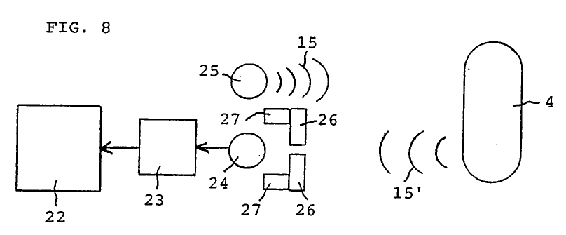

The invention can also be used in case the object is recorded by means of other means, in particular by means of sound waves. FIG. 8 shows schematically a corresponding arrangement, whereby an object 4 is impinged by means of sound waves 15 of an acoustic source 25. Thereby, the sound waves can be in the audible range or e.g. in the ultrasonic range. A sound receiver 24 receives sound waves 15′ reflected from the object 4 and an evaluation device 23, which optionally is coupled with a display device 22, produces an image of the object 4. Thereby, a relative movement between the object and a sound emitter and sound receiver also occurs in a known manner so that the entire object can be displayed. According to the invention, it is also provided an aperture 26 which opening is adjustable in its size according to the object size. In the Figure, adjusting means 27 are suggested. The recording of the object size of the object 4 for the adjustment of the aperture can thereby occur e.g. by means of separate sensors which are not shown in the Figure. At first, a pass by of the object 4 by means of the sound emitter and the sound transmitter can also occur without the aperture 26, whereby this pass by only serves for the recording of the dimensions of the object 4. After this, accordingly, the aperture 26 in front of the sound receiver 24 is adjusted and positioned and it occurs another line by line recording of the object 4 with the aperture 26 for a qualitative good display of the object. Accordingly, it can also be proceeded if the object is not recorded by means of the reflected sound but by means of such sound which goes through the object 4. Applications of the aperture in connection with the recording of the object with sound waves can be again in the medical field, in the testing of basic materials or echo-sounder recordings.

In the following, examples for radiograms with the aperture which is adjustable depending on the object are provided.

### EXAMPLES

1. As an example of the design according to FIG. 1:

As a tripod, it serves a commercially available multi-tripod with film cassettes or storage foils. Subsequently, an aperture with a control system is incorporated into the tripod. In this way, the reduction of the scattered light can be calculated in a first approximation as a proportion which results from the entire irradiated area without aperture to the passage area of the aperture.

### Calculation Example I

| | |
|---|---|
| Irradiated area without | 350 mm × 430 mm = 150500 mm2 |
| aperture: | |
| Passage area of the | 350 mm × 1 mm = 350 mm2 |
| aperture: | |
| Ratio to the aperture: | 430:1 or 0.2325% |

Without aperture 100% scattered radiation are generated; with aperture one achieves a reduction of the scattered radiation of 100%−0,2325%=99,7675%.

### Calculation Example II

| | |
|---|---|
| Passage area of the | 175 mm × 0.01 mm = 1.75 mm2 |
| aperture: | |
| Ratio area of the aperture: | 86000:1 or 0.001163% |

By means of this aperture the scattered radiation is reduced by 100%−0,001163=99,9987%.

2. Number of passes and time need:

The number of passes is normally 1.

The time need for a linear movement in the direction A depends on the size of the object and practicably amounts between 0,1 and 10 seconds.

1. Method for the recording of an object (4) by imaging by means of a radiation source (2) onto a recording means (3), in particular a film, whereby the object is x-rayed or illuminated and the object is recorded continuously or discontinuously line by line during the recording by means of at least one aperture (6) and a relative movement of the object on the one hand and recording means and optionally radiation source on the other hand, characterized in that the size of the focal aperture (9, 19) in direction of at least the dimension of the focal aperture, which lies in the direction of the relative movement, is adjusted depending on the object size, in particular is adjusted prior or during each recording.

2. The method according to claim 1, characterized in that the volume of the object, which is detected by the radiation field (5) of the radiation source (2), is used as object size.

3. Method according to claim 1, characterized in that, as object size, it is used the area of the object or a dimension of this area which is detected by the radiation field (5) of the radiation source (2) and which is opposite to the ray.

4. Method according to one of the claims 1 to 3, characterized in that the ray (5) is used as it exits the radiation source (2) or that the ray is limited by means of at least one collimator (2′) in front of the aperture.

5. Method according to one of the claims 1 to 4, characterized in that the object (4) and the recording means (3) are passed by the stationary radiation source (2) and the stationary aperture (6), whereby the aperture (6) is arranged between the radiation source (2) and the object (4) or whereby the aperture (6) is arranged between the object (4) and the recording means.

6. Method according to one of the claims 1 to 4, characterized in that the radiation source (2) and the aperture (6) are passed by the stationary object (4) and the stationary recording means (3), whereby the aperture (6) is arranged between the radiation source (2) and the object (4) or whereby the aperture (6) is arranged between the object (4) and the recording means (3) or whereby a first aperture (6) is arranged between the radiation source (2) and the object (4) and a second aperture (16) is arranged between the object (4) and the recording means (3).

7. Method according to one of the claims 1 to 6, characterized in that the relative movement occurs in direction of the breadth B of the object and the breadth b of the focal aperture is adjusted depending on the object size and optionally the height h of the focal aperture additionally is adjusted.

8. Method according to one of the claims 1 to 6, characterized in that the relative movement occurs in direction of the height of the object and the height h of the focal aperture is adjusted depending on the object height.

9. Method according to one of the claims 7 or 8, characterized in that the thickness t of the aperture is additionally adjusted, in particular in dependency on the object thickness T.

10. Method according to claim 1, characterized in that the focal aperture is adjusted depending on the output signal of a device (8, 11) to the object size detection.

11. Method according to one of the claims 1 to 10, characterized in that the focal aperture dimension to the object dimension is adjusted in a range of 1:10 to 1:100'000, preferably in a range of 1:100 to 1:100'000, further preferred in a range of 1:1'000 to 1:100'000, and further preferred in a range of 1:10'000 to 1:100'000.

12. Device for the recording of an object onto an recording means (3) by means of a radiation source (2), whereby the device comprises at least one aperture (6) and movement means for the relative movement between the aperture (6) and the object (4), and whereby an adjustment device (7, 11) for the adjustment of at least one focal aperture dimension and a detection device (8, 11) for the detection of at least one object dimension is provided and that the adjustment device is connected with the detection device such that the at least one focal aperture dimension is adjustable depending on the at least one detected object dimension, characterized in that the at least one adjustable focal aperture dimension is adjustable in direction of the relative movement.

13. Device according to claim 12, characterized in that it comprises an X-ray source (2) which ray is not collimated or limited by means of one collimator.

14. Device according to claim 12 or 13, characterized in that it comprises an object carrier (4′) and that the object carrier on the one hand and the aperture (6) on the other hand are movable relating to each other by means of the movement means (7, 11).

15. Device according to one of the claims 12 to 14, characterized in that the detection device comprises mechanical and/or optical sensors (8) for the detection of the object volume or at least one object dimension.

16. Device according to claim 14, characterized in that the radiation source (2) and the aperture (6) are secured to the device and that for this, the object carrier (4′) and the recording means (3) are movably arranged for the performance of the relative movement, whereby the aperture (6) is arranged between the radiation source (2) and the object carrier (4′) or hereby the aperture (6) is arranged between the object carrier and the recording means (3).

17. Device according to claim 14, characterized in that the object carrier and the recording means (3) are secured to the device and that for this, the radiation source (2) and the aperture (6) are movably arranged for the performance of the relative movement, whereby the aperture (6) is arranged between the radiation source (2) and the object carrier and the recording means (3) or whereby the aperture (6) is arranged between the object carrier and the recording means (3) or whereby a first aperture (6) is arranged between the radiation source (2) and the object carrier and a second aperture (16) is arranged between the object carrier and the recording means which is motion-coupled with the first aperture.

18. Method for the recording of an object by means of a sound source (25), whereby sound waves going through the object or sound waves reflected from the object are recorded and an image of the object is produced out of it, characterized in that it is provided at least one aperture (26) between the aperture and the recording means which focal aperture size is adjusted in at least one dimension prior to or during the recording depending on the object size, in particular on the object volume or at least one object dimension, in particular it is adjusted with each recording.

19. Method according to claim 18, characterized in that the focal aperture size is adjusted depending on the output signal of a device for the detection of the object size, or that a first recording with a predetermined focal aperture size value for the object size detection is performed so that afterwards the focal aperture size is adjusted depending on the object size and then the recording is made.

20. Method according to claim 18 or 19, characterized in that the breadth of the focal aperture is adjusted depending on the object breadth.

21. Method according to one of the claims 18 to 20, characterized in that the height of the focal aperture is adjusted depending on the object height.

22. Method according to one of the claims 18 to 22, characterized in that the thickness of the aperture is additionally adjusted.

23. Method according to one of the claims 18 to 22, characterized in that the focal aperture dimension to object dimension is in a range of 1:10 to 1:100'000, preferably in a range of 1:100 to 1:100'000, further preferred in a range of 1:1000 to 1:100'000 and further preferred in a range of 1:10'000 to 1:100'000.

24. Device for the recording of an object onto a recording means by means of sound, characterized in that in front of the recording means (24) for the recording of sound going through the object or sound being reflected from the object it is provided at least one aperture (26) with a focal aperture which is adjustable in at least one dimension.

25. Device according to claim 24, characterized in that it comprises a sound source (25), in particular a ultrasonic source.

26. Device according to claim 24 or 25, characterized in that it is provided a device for the object size detection as well as a device for the focal aperture adjustment responding to its output signal.
